(19) United States
(12) Patent Application Publication
(10) Pub. No.: US 2008/0140424 A1
(43) Pub. Date: Jun. 12, 2008

(54) METHOD AND APPARATUS FOR AUTO-RECORDING IMAGE DATA

(75) Inventors: Hyun-Soo Kim, Yongin-si (KR); Hyun-Sik Shim, Yongin-si (KR); Young-Hee Park, Seoul (KR); Je-Han Yoon, Seongnam-si (KR); Jong-Gyu Ham, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: Samsung Electronics Co., LTD, Suwon-si (KR)

(21) Appl. No.: 11/954,717

(22) Filed: Dec. 12, 2007

(30) Foreign Application Priority Data
Dec. 12, 2006 (KR) 2006-126235

(51) Int. Cl. H04N 7/173

(52) U.S. Cl. 704/278; 704/E21.017

(57) ABSTRACT

A auto-recording method is disclosed for auto-recording further to user request, via generating user image and voice data, extracting feature points from the image data according to pre-defined user recognition and following by considering the user as an object of following according to extracted feature points, determining whether the image and voice data satisfy a recording reference needed to perform recording. If determined that the image and voice data satisfy the recording reference, editing the image and voice data in a pre-set edit form and generating and storing at least one of recording image and recording voice data.

### PRIORITY

This application claims priority under 35 U.S.C. § 119(a) to a Patent Application filed in the Korean Intellectual Property Office on Dec. 12, 2006 and assigned Serial No. 2006-126235, the contents of which are incorporated herein by reference.

### BACKGROUND OF THE INVENTION

1. Field of the Invention

The present invention relates generally to auto-recording of image data, and, in particular, to a method and apparatus for generating image data and voice data of a pre-designated object of following, editing the image data and the voice data in a pre-set edit form, and storing the image data and the voice data.

2. Description of the Related Art

Auto-recording allows for automatically recording of image data and voice data generated according to a pre-set auto-recording setting, such as a reference time or a user request. For example, auto-recording devices include a car surveillance camera that measures the speed of passing vehicles and, if the speed of a vehicle exceeds a pre-set reference speed, captures the license plate of the vehicle, resulting in generation of image data. Another example is an auto-recording thermometer for automatically measuring and recording a temperature at a pre-set time interval.

Recently, most people own one portable terminal, on average, and most portable terminals are equipped with a digital camera, allowing a user to capture, edit and store image data of interest, and the user can upload the image data to a blog or create a digital album with the image data in the future.

A “blog” means a website to which content, such as image data or video data captured by a digital camera or text, can be uploaded according to the interest of a user. In order to upload image and video data of interest to a blog, according to the existing technology, a user captures, edits and stores the image and video data, and uploads the image and video data to the blog for future viewing.

For example, when a user photographs a bride and a bridegroom at a wedding ceremony using a digital camera and uploads the captured image data to a blog of the user, the captured image data is transmitted from the digital camera to a Personal Computer (PC). Thereafter, the user edits the image data using an image processing program, such as Adobe Photoshop, and uploads the edited image data to the blog.

However, when the user performs this procedure, it takes long time for the user to directly capture and edit the image data. It is also inconvenient for the user to directly capture and edit the image data. Thus, an apparatus for auto-recording image data is needed to automatically perform the procedures of manually capturing and editing the image data.

### SUMMARY OF THE INVENTION

An aspect of the present invention is to substantially solve at least the above problems and/or disadvantages and to provide at least the advantages below. Accordingly, an aspect of the present invention is to provide a method and apparatus for saving time taken when a user edits image data.

Another aspect of the present invention is to provide a method and apparatus for removing inconvenience for a user to directly capture and edit image data.

According to one aspect of the present invention, there is provided a method of auto-recording image data, the method including when auto-recording is requested by a user, generating image data and voice data of an arbitrary user; extracting feature points of the arbitrary user from the image data according to pre-defined user recognition and following the arbitrary user by considering the arbitrary user as an object of following according to the extracted feature points; if the arbitrary user is considered as the object of following, determining whether the image data and the voice data satisfy a recording reference, which must be satisfied in order to perform recording; if it is determined that the image data and the voice data satisfy the recording reference, editing the image data and the voice data in a pre-set edit form and generating and storing at least one of recording image data and recording voice data; and if termination of the auto-recording is not requested by the user, repeating the steps by going back to the generating of image data and voice data.

According to another aspect of the present invention, there is provided an apparatus for auto-recording image data, the apparatus including an information input unit for generating image data and voice data of an arbitrary user; a recognition processing unit for extracting feature points by performing user recognition with the image data, comparing the extracted feature points and pre-stored feature points of image data of an object of following, and determining, according to a result of the comparison, whether the arbitrary user is the object of following; a following unit for setting the arbitrary user as the object of following and following the arbitrary user if it is determined that the arbitrary user is the object of following; an information selector for determining whether the image data and the voice data satisfy a recording reference, which is the minimum condition in order to perform recording; an information editor for editing the image data and the voice data in a pre-set edit form and generating at least one of recording image data and recording voice data if it is determined that the image data satisfies the recording reference; a memory unit for pre-storing the image data and voice data of the object of following and storing the recording image data and the recording voice data; and a controller for controlling the information input unit, the information selector, the recognition processing unit, and the information editor to generate the recording image data and the recording voice data when auto-recording is requested by a user, controlling the apparatus to follow the object of following according to the feature points of the object of following generated by the following unit, and controlling the information input unit, the information selector, the recognition processing unit, and the information editor to continuously generate recording image data and recording voice data if termination of the auto-recording is not requested by the user.

### BRIEF DESCRIPTION OF THE DRAWINGS

The above and other objects, features and advantages of the present invention will become more apparent from the following detailed description when taken in conjunction with the accompanying drawing in which:

FIG. 1 is a block diagram of an apparatus for auto-recording image data according to an exemplary embodiment of the present invention;

FIG. 2 is a flowchart of a method of setting an auto-recording function according to an exemplary embodiment of the present invention;

FIG. 3 is a flowchart of a method of performing the auto-recording function according to an exemplary embodiment of the present invention; and

FIG. 4 is an illustration of a process for performing the auto-recording function according to an exemplary embodiment of the present invention.

### DETAILED DESCRIPTION OF THE PREFERRED EMBODIMENTS

Preferred embodiments of the present invention are described herein below with reference to the accompanying drawings. In the following description, well-known functions or constructions are not described in detail since they would obscure the invention in unnecessary detail.

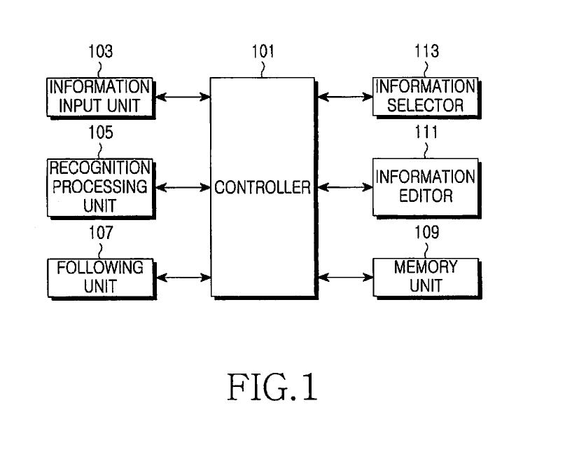

FIG. 1 is a block diagram of an apparatus for auto-recording image data according to an exemplary embodiment of the present invention. Operations of components of the apparatus will now be described with reference to FIG. 1, in which an image auto-recording apparatus includes a controller 101, an information input unit 103, a recognition processing unit 105, a following unit 107, a memory unit 109, an information editor 111 and an information selector 113, all of which are connected to the controller 101.

The information input unit 103 receives external image information and voice information, and generates image data and voice data, under the control of the controller 101. In more detail, the information input unit 103 includes an image sensor (not shown) and a voice sensor (not shown), generates image data by digitizing an image projected on the image sensor, and generates voice data by digitizing a sound sensed by the voice sensor. The image data may be still image data or video data.

The recognition processing unit 105 performs user recognition by receiving the image data from the information input unit 103, extracting feature points according to a pre-defined type of user recognition, and comparing the extracted feature points and pre-stored feature points of image data of an object of following. If image recognition reliability derived as a result of the image recognition exceeds pre-defined reference image recognition reliability, the recognition processing unit 105 determines that the currently received image data corresponds to image data and voice data of the object of following. If the image recognition reliability does not exceed the pre-defined reference image recognition reliability, the recognition processing unit 105 determines that the currently received image data is not the image data of the object of following. For example, if the received image data corresponds to a front view of an arbitrary user, the recognition processing unit 105 can perform user recognition through face recognition or dress color recognition. For another example, if the received image data corresponds to a rear view of the arbitrary user, the recognition processing unit 105 can perform user recognition through recognition of an omega shape represented by a face and shoulders.

If it is determined as a result of the user recognition of the recognition processing unit 105 that the currently received image data is the image data of the object of following, the following unit 107 considers the user corresponding to the currently received image data as the object of following and follows the user. In order to maintain a proper distance with the object of following, the following unit 107 measures a distance from the object of following using an ultrasonic sensor (not shown) or a laser sensor (not shown) and controls the measured distance to maintain a constant distance.

If it is determined as a result of the user recognition of the recognition processing unit 105 that the currently received image data is the image data of the object of following, the information selector 113 selects image data and voice data satisfying pre-set image and voice references from among currently generated image data and voice data. In more detail, the information selector 113 receives and analyzes the currently generated image data and voice data under the control of the controller 101. The information selector 113 selects only image data and voice data satisfying the pre-set image and voice references from among the analyzed image data and voice data. The information selector 113 outputs the selected image data and voice data to the information editor 111.

The image reference is a reference that currently generated image data must satisfy. For example, the image reference preferably includes a first image reference for determining whether the image data contains a face of an arbitrary object and a second image reference for determining whether the image data was captured when the face of the arbitrary object was oriented between left/right 45° from the front direction. The image reference preferably further includes a third image reference for determining whether the image data was captured when the face of the arbitrary object was smiling. The image reference preferably further includes a fourth image reference for determining whether brightness of the image data satisfies a pre-set brightness reference and a fifth image reference for determining whether the image data was captured when the arbitrary object was handshaking with another object.

The voice reference is a reference that currently generated voice data must satisfy. For example, the voice reference may include a first voice reference for determining whether the voice data satisfies a pre-set sound magnitude and a second voice reference for determining whether a noise level included in the voice data is less than a pre-set noise level. Hereinafter, the image reference and the voice reference are referred to as a recording reference.

Other various conditions can be contained in the image reference and the voice reference, and the image reference and the voice reference can vary according to the purpose of the use of the image auto-recording apparatus.

The information editor 111 receives image data and voice data stored in the memory unit 109, cancels noise from the image data and the voice data, and edits the image data and the voice data in a pre-set edit form. In more detail, the information editor 111 receives image data and voice data stored in the memory unit 109. The information editor 111 cancels noise from the image data and cancels all voices except the voice of the object of following. The information editor 111 generates recording image data by image-processing the image data in the pre-set edit form, converting the voice data to text data in the pre-set edit form, and inserting the text data into an arbitrary area of the image data. The information editor 111 stores the recording image data in the memory unit 109.

The edit form indicates a format used when image data and voice data are edited, and is set by the user in advance. For example, the edit form may include image resolution, brightness and saturation of image data. The edit form may further include a character size, a character color and a font when voice data is converted to text data. The edit form may further include volume control in which volume of voice is adjusted when voice data is edited.

The memory unit 109 stores data required to control the image auto-recording apparatus. In particular, the memory unit 109 stores image data and voice data of a pre-designated object of following. The memory unit 109 receives the recording image data and the recording voice data, which was generated by editing the image data and the voice data of the object of following in the edit form pre-set by the user, from the information editor 111 and stores the recording image data and the recording voice data.

The controller 101 controls the image auto-recording apparatus to perform various functions. In particular, when the user requests setting of auto-recording, the controller 101 controls the information input unit 103 to generate image data and voice data of an arbitrary user and set the image data and the voice data of the arbitrary user as image data and voice data of an object of following. When setting of an edit form is requested by the user, the controller 101 controls the information editor 111 to inform the user of at least one edit form provided by a pre-designated editing emulator, and receives and sets an edit form selected by the user.

When an image auto-recording function is requested by the user, the controller 101 receives currently generated image data from the information input unit 103 and outputs the currently generated image data to the recognition processing unit 105. The controller 101 controls the recognition processing unit 105 to determine whether the currently generated image data is image data of an object of following. If it is determined that the currently generated image data is image data of the object of following, the controller 101 controls the following unit 107 to follow an arbitrary user corresponding to the currently generated image data.

The controller 101 outputs the currently generated image data and voice data to the information selector 113. The controller 101 controls the information selector 113 to determine whether the currently generated image data and voice data satisfy a pre-defined recording reference. If it is determined that the currently generated image data and voice data satisfy the pre-defined recording reference, the controller 101 outputs the currently generated image data and voice data to the information editor 111. The controller 101 controls the information editor 111 to generate recording image data and recording voice data by editing the currently generated image data and voice data.

For example, the controller 101 controls the information editor 111 to generate editing image data by editing the received image data in a pre-set edit form. The controller 101 also controls the information editor 111 to convert the received voice data to text data according to the pre-set edit form. The controller 101 further controls the information editor 111 to generate recording image data by searching editing image data corresponding to the converted text data and adding the text data to a predetermined area of the found editing image data. The controller 101 can store the recording image data in the memory unit 109.

As another example, the controller 101 can search image data and voice data determined as image data and voice data of the object of following from the memory unit 109 and output the found image data and voice data to the information editor 111. The controller 101 can control the information editor 111 to generate recording image data by editing the received image data in the pre-set edit form. The controller 101 can also control the information editor 111 to generate recording voice data by searching voice data corresponding to the generated recording image data and editing the found voice data in the pre-set edit form. The controller 101 can store the recording image data in the memory unit 109, and store the recording voice data to correspond to the recording image data.

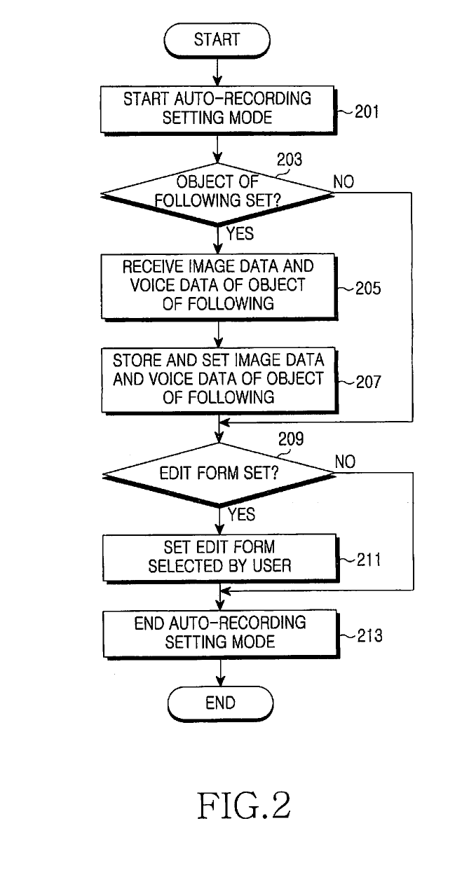

The components of the image auto-recording apparatus have been described with reference to FIG. 1. FIG. 2 is a flowchart of a process of setting an object of following and an edit form according to an exemplary embodiment of the present invention. Referring to FIG. 2, if an auto-recording setting mode for setting an object of following and an edit form is requested by a user in step 201, the controller 101 proceeds to step 203.

The controller 101 determines in step 203 whether setting of an object of following, which is an object of auto-recording, has been requested by the user. If it is determined in step 203 that setting of an object of following has been requested by the user, the controller 1001 proceeds to step 205, in which image data and voice data of the object of following are received. If it is determined in step 203 that setting of an object of following has not been requested by the user, the controller 101 proceeds to step 209, in which an edit form of an editing emulator is set, as described below.

In step 205, the controller 101 receives image data and voice data of an arbitrary user by controlling the image sensor and the voice sensor included in the information input unit 103. The controller 101 checks the noise level of the image data and voice data of the arbitrary user. If the checked noise level is greater than a predetermined reference noise level, the controller 101 informs the user of a message for requesting receipt to new image data and new voice data. Accordingly, the controller 101 receives new image data and new voice data. If the checked noise level is less than the predetermined reference noise level, the controller 101 proceeds to step 207.

The controller 101 sets the image data and voice data input from the information input unit 103 as the image data and voice data of the object of following in step 207 and proceeds to step 209, in which an edit form is set.

The controller 101 determines in step 209 whether setting of an edit form has been requested by the user. If it is determined in step 209 that setting of an edit form has been requested by the user, the controller 101 proceeds to step 211. If it is determined in step 209 that setting of an edit form has not been requested by the user, the controller 101 proceeds to step 213, in which the auto-recording setting mode ends.

The controller 101 informs the user of at least one edit form provided by the editing emulator and sets an edit form selected by the user from among the at least one edit form in step 211.

For example, the controller 101 can display an illumination control menu for controlling illumination of image data, an illuminance control menu for controlling illuminance of the image data a brightness control menu for controlling brightness of the image data, and a background selection menu for selecting a background of the image data to the user in an edit form used when the image data is edited. If the illumination control menu is selected by the user from among the displayed menus, the controller 101 can receive an illumination value to change illumination of arbitrary image data. The controller 101 can set the received illumination value as an illumination value of a selected edit form.

As another example, the controller 101 can display a character size control menu for controlling a character size of text data, a font selection menu for selecting a character font and a character color selection menu for selecting a character color to the user in an edit form used when voice data is converted to text data. If the character color selection menu is selected by the user from among the displayed menus, the controller 101 can receive a character color for determining a color of text when voice data is converted to text data. The controller 101 can set the received character color as a character color of a selected edit form.

In step 213, the controller 101 ends the auto-recording setting mode in which an object of following and an edit form are set.

Although it has been described that only one arbitrary user is set as an object of following when the object of following is set in the auto-recording setting mode, in a preferred embodiment a plurality of arbitrary users are set as objects of following.

In addition, although it has been described that an object of following and an edit form are set in the auto-recording setting mode, other settings are also set. For example, an auto-recording reservation function in which a start time for starting an auto-recording function and an end time for ending the auto-recording function are set in advance are set.

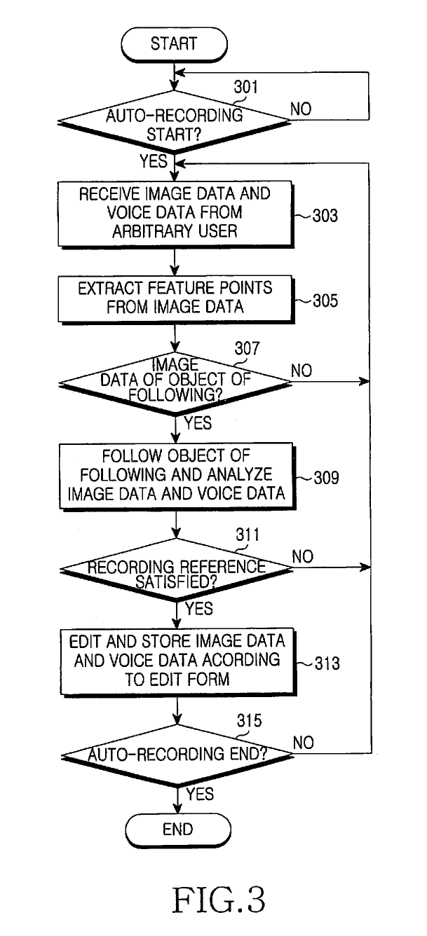

FIG. 3 is a flowchart of a method of performing the auto-recording function according to an exemplary embodiment of the present invention.

Referring to FIG. 3, if the auto-recording function starts according to a user request in step 301, the controller 101 proceeds to step 303. Otherwise the controller 101 repeats step 301.

For example, if the auto-recording function is requested by a user, the controller 101 immediately starts the auto-recording function, and if a time at which the auto-recording function starts is reserved in advance by the user, the controller 101 can start the auto-recording function when the current time is the reserved time.

The controller 101 controls the information input unit 103 to generate image data and voice data of an arbitrary user. In more detail, the controller 101 controls the information input unit 103, including the image sensor and the voice sensor, to generate image data using an image signal currently sensed by the image sensor and generate voice data using a voice signal currently sensed by the voice sensor.

In step 305, the controller 101 receives the currently generated image data from the information input unit 103 and outputs the currently generated image data to the recognition processing unit 105. In addition, the controller 101 controls the recognition processing unit 105 to extract feature points from the currently generated image data according to a pre-designated user recognition type. The recognition processing unit 105 performs user recognition by comparing the extracted feature points and pre-stored feature points of image data of an object of following.

In step 307, the controller 101 controls the recognition processing unit 105 to determine, as a result of the user recognition performed in step 305, whether the currently generated image data is image data of the object of following. If it is determined in step 307 that the currently generated image data is image data of the object of following, the controller 101 proceeds to step 309. Otherwise the controller 101 returns to step 303.

For example, the recognition processing unit 105 can calculate image recognition reliability as a result of the user recognition. If the calculated image recognition reliability exceeds pre-defined reference image recognition reliability, the recognition processing unit 105 can determine that the currently generated image data is image data of the object of following, and the process proceeds to step 309. If the calculated image recognition reliability does not exceed the pre-defined reference image recognition reliability, the recognition processing unit 105 can determine that the currently generated image data is not image data of the object of following and the process returns to step 303.

In step 309, the controller 101 controls the following unit 107 to consider an arbitrary user corresponding to the currently generated image data as the object of following and follows the arbitrary user.

The controller 101 outputs the currently generated image data and voice data to the information selector 113. The controller 101 controls the information selector 113 to determine in step 311 whether the currently generated image data and voice data satisfy a pre-defined recording reference. The recording reference includes an image reference and a voice reference, wherein the image reference is a reference that the image data must satisfy, and the voice reference is a reference that the voice data must satisfy.

If it is determined in step 311 that the currently generated image data and voice data satisfy the recording reference, the controller 101 proceeds to step 313. Otherwise the controller 101 returns to step 303.

In step 313, the controller 101 outputs the currently generated image data and voice data to the information editor 111. The controller 101 also controls the information editor 111 to generate recording image data by editing the currently generated image data in a pre-set edit form and generate recording voice data by editing the currently generated voice data in a pre-set edit form. The controller 101 also stores at least one of the recording image data and the recording voice data in the memory unit 109.

For example, the information editor 111 generates editing image data by editing image data in a pre-set image data edit form. The information editor 111 also generates text data in a pre-set text data edit form when voice data is converted to text data. The information editor 111 further generates recording image data by searching text data corresponding to the editing image data and adding the found text data to a partial area of the editing image data. The information editor 111 also stores the recording image data in the memory unit 109.

If termination of the auto-recording function is requested by the user in step 315, the controller 101 ends the auto-recording function. Otherwise the controller 101 returns to step 303.

For example, if termination of the auto-recording function is requested by the user, the controller 101 can end the auto-recording function. For another example, if an auto-recording end time for ending the auto-recording function is reserved by the user, when a current time is the auto-recording end time, the controller 101 can automatically end the auto-recording function.

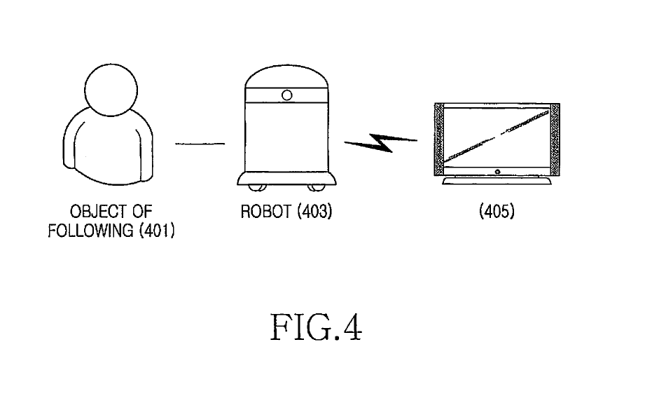

The process of performing the auto-recording setting mode and the process of performing the auto-recording function have been described with reference to FIGS. 2 and 3. A process of performing the auto-recording function in a robot 403 having the auto-recording function will now be described with reference to FIG. 4.

Referring to FIG. 4, if execution of the auto-recording function is requested by a user, the robot 403 having the auto-recording function can receive image data and voice data of an object 401 of following while following the object 401 of following, and can generate and store recording image data and recording voice data by editing the image data and the voice data in a pre-set edit form.

If the robot 403 communicates with a display unit 405 and a sound processing unit (not shown), the robot 403 can display at least one piece of recording image data or output at least one piece of recording voice data according to a user's request. If the robot 403 does not communicate with or include display unit 405, the robot 403 can transmit at least one piece of recording image data and at least one piece of recording voice data to a terminal including the display unit 405 via wired/wireless communication.

In the present invention, it has been described that an image auto-recording apparatus generates recording image data and recording voice data using arbitrary image data and voice data while performing the auto-recording function. However, the image auto-recording apparatus can generate at least one piece of recording image data and at least one piece of recording voice data using at least one piece of image data and at least one piece of voice data corresponding to an object of following after the auto-recording function is terminated.

As described above, according to the present invention, the time taken when an arbitrary user edit image data can be reduced, the image data can be automatically generated, and the image data can be automatically edited.

While the invention has been shown and described with reference to a certain preferred embodiment thereof, it will be understood by those skilled in the art that various changes in form and details may be made therein without departing from the spirit and scope of the invention, as defined by the appended claims.

What is claimed is:

1. A method of auto-recording image data, the method comprising:
when auto-recording is requested by a user, generating image data and voice data of an arbitrary user;
extracting feature points of the arbitrary user from the image data according to pre-defined user recognition and following the arbitrary user by considering the arbitrary user as an object of following according to the extracted feature points;
if the arbitrary user is considered as the object of following, determining whether the image data and the voice data satisfy a recording reference, which must be satisfied to perform recording;
if it is determined that the image data and the voice data satisfy the recording reference, editing the image data and the voice data in a pre-set edit form and generating and storing at least one of recording image data and recording voice data; and
if termination of the auto-recording is not requested by the user, repeating the by returning to the generating of image data and voice data step.

2. The method of claim 1, further comprising returning to the generating of image data and voice data of an arbitrary user if the arbitrary user is not considered as the object of following in the following of the arbitrary user.

3. The method of claim 1, further comprising, if a recording data notice is requested by the user, informing the user of the recording image data and recording voice data.

4. The method of claim 1, wherein the storing comprises:
generating editing image data by editing the image data in edit form;
converting the voice data to text data according to the edit form; and
generating the recording image data by adding the text data to the editing image data and storing the recording image data.

5. The method of claim 1, wherein the storing comprises:
generating recording image data by editing the image data in edit form;
converting recording voice data by editing the voice data in the edit form; and
storing the recording voice data to correspond to the recording image data.

6. The method of claim 1, wherein the recording reference comprises an image reference, which is a minimum condition satisfied in order for image data to be recorded, and a voice reference, which is a minimum condition satisfied in order for voice data to be recorded.

7. The method of claim 4, wherein the edit form comprises at least one of illumination, illuminance, brightness and background related to the image data.

8. The method of claim 4, wherein the edit form comprises at least one of a character size, a character color and a character font related to the text data.

9. The method of claim 5, wherein the edit form comprises volume of voice related to the voice data.

10. The method of claim 1, wherein the user recognition comprises at least one of face recognition, dress color recognition and height recognition when the image data corresponds to a front view of the object of following.

11. The method of claim 1, wherein the user recognition comprises recognition of an omega shape represented by a face and shoulders when the image data corresponds to a rear view of the object of following.

12. An apparatus for auto-recording image data, the apparatus comprising:
an information input unit for generating image data and voice data of an arbitrary user;
a recognition processing unit for extracting feature points by performing user recognition with the image data, comparing the extracted feature points and pre-stored feature points of image data of an object of following, and determining according to a result of the comparison whether the arbitrary user is the object of following;
a following unit for setting the arbitrary user as the object of following and following the arbitrary user if it is determined that the arbitrary user is the object of following;
an information selector for determining whether the image data and the voice data satisfy a recording reference, which is a minimum condition to perform recording;
an information editor for editing the image data and the voice data in a pre-set edit form and generating at least one of recording image data and recording voice data if it is determined that the image data satisfies the recording reference;
a memory unit for pre-storing the image data and voice data of the object of following and storing the recording image data and the recording voice data; and
a controller for controlling the information input unit, the information selector, the recognition processing unit and the information editor to generate the recording image data and the recording voice data when auto-recording is requested by a user, controlling the apparatus to follow the object of following according to the feature points of the object of following generated by the following unit, and controlling the information input unit, the information selector, the recognition processing unit and the information editor to continuously generate recording image data and recording voice data if termination of the auto-recording is not requested by the user.

13. The apparatus of claim 12, wherein, if it is determined that the arbitrary user is not the object of following, the controller generates recording image data and recording voice data using newly generated arbitrary image data and arbitrary voice data.

14. The apparatus of claim 12, wherein, if a recording data notice is requested by the user, the controller informs the user of the recording image data and the recording voice data.

15. The apparatus of claim 12, wherein the information editor generates editing image data by editing the image data in the edit form, converts the voice data to text data according to the edit form, generates the recording image data by adding the text data to the editing image data and stores the recording image data.

16. The apparatus of claim 12, wherein the information editor generates recording image data by editing the image data in the edit form, converts recording voice data by editing the voice data in the edit form and stores the recording voice data to correspond to the recording image data.

17. The apparatus of claim 12, wherein the recording reference comprises an image reference, which is the minimum condition satisfied in order for image data to be recorded, and a voice reference, which is the minimum condition satisfied in order for voice data to be recorded.

18. The apparatus of claim 15, wherein the edit form comprises at least one of illumination, illuminance, brightness and background related to the image data.

19. The apparatus of claim 15, wherein the edit form comprises at least one of a character size, a character color and a character font related to the text data.

20. The apparatus of claim 16, wherein the edit form comprises volume of voice related to the voice data.

21. The apparatus of claim 12, wherein the following unit measures a distance from the object of following using an ultrasonic sensor or a laser sensor and controls the measured distance to maintain a constant distance.

22. The apparatus of claim 12, wherein the user recognition comprises at least one of face recognition, dress color recognition and height recognition when the image data corresponds to a front view of the object of following.

23. The apparatus of claim 12, wherein the user recognition comprises recognition of an omega shape represented by a face and shoulders when the image data corresponds to a rear view of the object of following.
